(19) United States
(12) Patent Application Publication
(10) Pub. No.: US 2023/0039235 A1
(43) Pub. Date: Feb. 9, 2023

(54) EMOTIONALLY-AWARE CONVERSATIONAL RESPONSE GENERATION METHOD AND APPARATUS

(71) Applicant: VERIZON PATENT AND LICENSING INC., Basking Ridge, NJ (US)

(72) Inventors: Subham BISWAS, Thane (IN); Bharatwaaj SHANKAR, Chennai (IN); Saurabh TAHILIANI, Noida (IN)

(73) Assignee: VERIZON PATENT AND LICENSING INC., Basking Ridge, NJ (US)

(21) Appl. No.: 17/393,434

(22) Filed: Aug. 4, 2021

(51) Int. Cl. G10L 15/16; G10L 25/63; G10L 15/22

(52) U.S. Cl. CPC G10L 15/16; G10L 25/63; G10L 15/22; G10L 2015/227

(57) ABSTRACT

Techniques for generating conversational responses for a conversational user interface are disclosed. In one embodiment, a method is disclosed comprising obtaining user input from a user via a conversational user interface, using the user input to obtain a user emotion and a user intent, obtaining candidate probabilities for a fragment of a response to the user input using the obtained user emotion, the obtained user intent and the user input, generating the response to the user input using the candidate probabilities obtained for the fragment to select a candidate for the fragment of the response, and communicating the response to the user via the conversational user interface.

### BACKGROUND INFORMATION

Software applications, such as chatbots or other dialog-based applications, can be used in place of a human being to interact with a user. Frequently, a user wishes to obtain some assistance from a customer service representative, technical support representative, or the like, but is instead directed to chatbots. Unfortunately, many chatbots use a rule-based approach that is limited to a set of predefined responses and cannot effectively emulate a human response or human interaction.

### BRIEF DESCRIPTION OF THE DRAWINGS

FIG. 1 provides an example illustrating conversational response generation in accordance with one or more embodiments of the present disclosure;

FIG. 2 provides examples of training data sources for use in training an emotion classifier in accordance with one or more embodiments;

FIG. 3 provides an example illustrating candidate selection in accordance with one or more embodiments of the present disclosure;

FIG. 4 provides examples of user input and response combinations in accordance with one or more embodiments of the present disclosure;

FIG. 5 provides example of conversation data that can be used in tuning conversational response generator in accordance with one or more embodiments;

FIG. 6 provides an example illustrating feedback used in tuning a conversational response generator in accordance with one or more embodiments of the present disclosure;

FIG. 7 provides an example of a conversational response generation process flow used in accordance with one or more embodiments of the present disclosure;

FIG. 8 is a schematic diagram illustrating an example of a network within which the systems and methods disclosed herein could be implemented according to some embodiments of the present disclosure;

FIG. 9 depicts is a schematic diagram illustrating an example of client device in accordance with some embodiments of the present disclosure; and

FIG. 10 is a block diagram illustrating the architecture of an exemplary hardware device in accordance with one or more embodiments of the present disclosure.

### DETAILED DESCRIPTION OF EXAMPLE EMBODIMENTS

The disclosed embodiments can be used in dynamically formulating a response to user input using emotion and intent predictions determined by trained emotion and intent classifiers using the user input. In accordance with one or more embodiments, the user input, emotion prediction and intent prediction can be used by an attention-based neural network model to generate, for a fragment of a response to the user input, candidate probabilities. The candidate probabilities associated with each response fragment can be used by a sentence generator to formulate a response that is based on the user input.

In accordance with one or more embodiments, the response provided by the sentence generator can include one or more placeholders which can be replaced with corresponding user data by a placeholder filler component with access to stored user data. The formulated response can be provided to the user in a conversational user interface of an application (e.g., web application, mobile application, chatbot) in response to the user input received via the application's conversational user interface.

A tool, such as Google Dialogflow®, can be used to design and integrate a conversational user interface into a software application. Dialogflow® uses a rule-based approach to identify a response to user input. A significant disadvantage of a rule-based approach is its inability to adapt to different user input. With a rule-based approach, words in a user's input are used with a predefined set of rules, finite in number, that are used to select a predefined response from a finite number of predefined responses.

The disclosed embodiments use machine learning and provide a conversational response generator to dynamically generate a unique conversational response to user input. In accordance with one or more embodiments, user input is used to determine an emotion and intent for the user input. The emotion, intent and user input are then used by a trained machine learning model to provide a set of probabilities associated with a set of candidates for each of a number of fragments of a response. The set of candidates and probabilities can then be used by a sentence generator to generate a response to the user input by selecting a candidate for a fragment of the response. Response 128 can comprise a number (e.g., one or multiple) of fragments. For a current fragment, the sentence generator can use the fragment's candidate probabilities and candidates selected for other fragments to select a candidate for the current fragment. The sentence generator can use an iterative process to obtain each fragment's candidate probabilities, select a candidate for each fragment of the response 128 and generate the response 128 to user input by assembling the response 128 using the candidate selected for each of multiple fragments. In accordance with one or more embodiments, beam search and nucleus sampling can be used as the sentence generator.

In accordance with one or more embodiments, the model trained to provide the candidate probabilities to be used in formulating a response can be a trained statistical machine model, such as an attention-based neural network model. In accordance with one or more embodiments, the attention-based neural network model can be trained using historical data including a number of user input and response pairings.

In accordance with one or more embodiments, the trained attention-based neural network model can be tuned using user input and response pairings. By way of a non-limiting example, a response paired with user input can be a response generated by the conversational response generator using the user input. Each user input and response pair can have an associated emotion, emote score, intent and intent probability. The emotion, emote score, intent and intent probability associated with a user input and response pairing can be determined using the user input and can then be used in generating the response. The emotion, emote score, intent and intent probability can be used with the associated user input and response pairing to generate the training data used to tune the trained attention-based neural network.

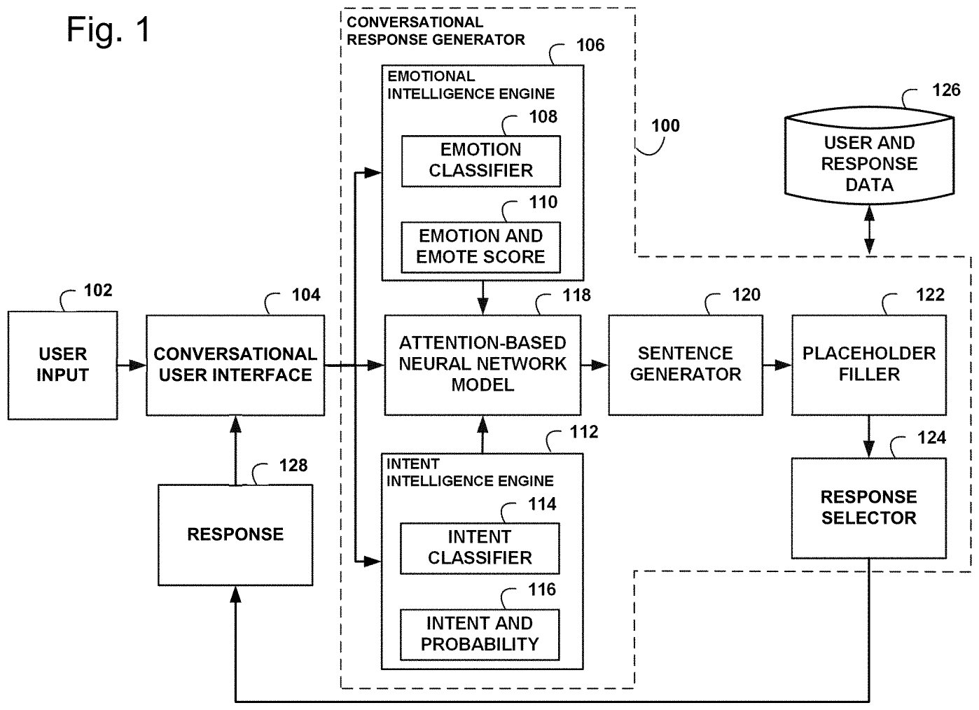

FIG. 1 provides an example illustrating conversational response generation in accordance with one or more embodiments of the present disclosure. In accordance with one or more embodiments, conversational response generator 100 can receive user input 102 and generate a response 128 for display in conversational user interface 104. In accordance with one or more embodiments, user input 102 can be received by conversational response generator 100 via conversational user interface 104. In accordance with one or more embodiments, conversational user interface 104 can be displayed at a client computing device of the user providing user input 102.

In accordance with one or more embodiments, conversational response generator 100 can include an emotional intelligence engine 106, an intent intelligence engine 112, an attention-based neural network model 118, a sentence generator 120, a placeholder filler 122 and a response selector 124. In accordance with one or more embodiments, emotional intelligence engine 106 can comprise a trained machine learning model, such as emotion classifier 108, trained to identify an emotion and emote score 110 using the user input 102. The emote score can indicate an intensity of the identified emotion.

In accordance with one or more embodiments, emotion classifier 108 can be trained using a machine learning algorithm and supervised learning, such that each training example in a set of training examples includes a label identifying the emotion associated with the training example's training data. A training example's training data can be generated using historical user input (e.g., previously-received input from a user).

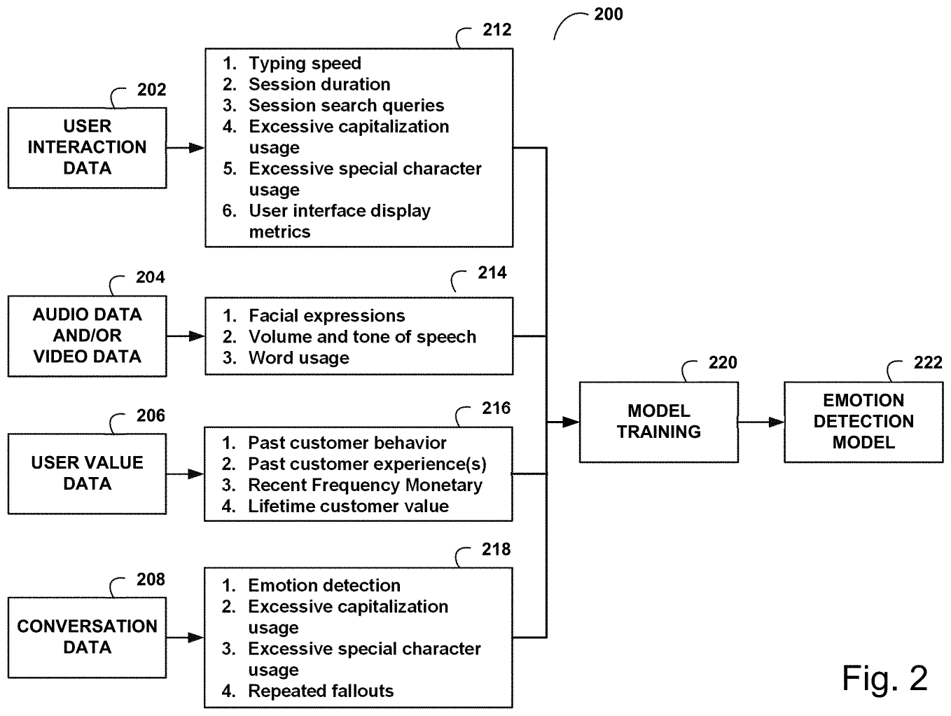

FIG. 2 provides examples of training data sources for use in training emotion classifier 108. In example 200 shown in FIG. 2, training data can be obtained from a number of sources, including user interaction data 202, audio data and/or video data 204, user value data 206 and conversation data 208. Data from sources such as these can be used to generate training examples to train emotion classifier 108.

By way of a non-limiting example, user interaction data 202 can comprise historical information presenting user navigation with an application (e.g., the application connected with the conversational user interface 104). User interaction data 202 can be grouped by user and session. As used herein, a session can be a collection or group of interactions with a user in a given time frame, where the time frame can be a defined amount of time (e.g., 30 minutes) or time of actual interaction to account for lapses in attention (e.g. 5 minutes of actual input in a 15 minute session). Block 212 provides some examples of user interaction data, which include typing speed, session duration, session search queries, excessive capitalization usage, excessive special character usage, and user interface display metrics.

Typing speed can include information indicating how fast a user types. Session duration can comprise temporal information indicating a duration of a user's session. By way of a non-limiting example, session duration can be associated with a user's visit to a website and the session duration's temporal information can indicate the length of time that the user spent at the website. Session search queries can include information indicating the number and content of queries input by a user during a session. The excessive capitalization usage and excessive special character usage examples can identify the presence or absence (and/or measure) of each type of usage by a user during a session. User interface display metrics relate to a given user interface display (e.g., a window, page, dialog, popup or the like) and can include information indicating the time it took for the display to load, the time that a user spent viewing the display, number of views, and whether or not an error occurred in connection with the display.

Data 204 can include audio data and/or video data. By way of a non-limiting example, the audio and/or video data can be captured by a user's device during a session. As illustrated in block 214, examples of audio data and video data include facial expressions, volume and tone of speech and word usage. A camera (or other digital image capturing device) can be used to capture the user's facial expressions which can indicate a user's reaction to an application's output (e.g., contents of a device's output such as and without limitation text, audio, video, multimedia or the like). Some examples of facial expressions include frowning, smiling, surprise, etc.

Volume and tone of speech can include information indicating whether the user was speaking at a normal volume or shouting and/or whether the user used a certain tone of voice when speaking, such as and without limitation a happy, sad, serious, formal, etc. tone of voice. Word usage can include information identifying types of words used and the manner in which the words were used.

User value data 206 can include information indicating a user's value as a customer of an entity, such as and without limitation an electronic commerce, or ecommerce, entity providing goods and or services. With reference to block 216, some examples of information from this data source include past customer behavior, past customer experience(s), recent frequency monetary and lifetime customer value.

Past customer behavior can include information about a user's buying behavior with respect to the goods or services provided by an entity. Past customer experience(s) can include information relating to a user's perception or feeling about an entity, its brand, etc. Recency frequency monetary (RFM) values can be used as an indicator of a user's (or consumer's) value to the entity and can include information indicating how recently the user made a purchase, frequency of the user's purchases, and how much the user spent (or spends).

Conversation data 208 can include data from past conversations with a user, such as conversations with the user using conversational user interface 104. Examples of information from this source shown in block 218 include emotion detection, excessive capitalization usage, excessive special character usage and repeated fallouts. Emotion detection can include information indicating a user's emotion determined using emotional intelligence engine 106.

Although not shown in example 200?, sentiment detection is another example of information provided with the conversation data 208. Sentiment detection information can indicate whether the user has a positive, negative or neutral sentiment. Sentiment detection can be provided using a sentiment analyzer to analyze user input to detect a positive, negative, or neutral expression. A sentiment can also include a tone, such as a sad, happy, etc. tone.

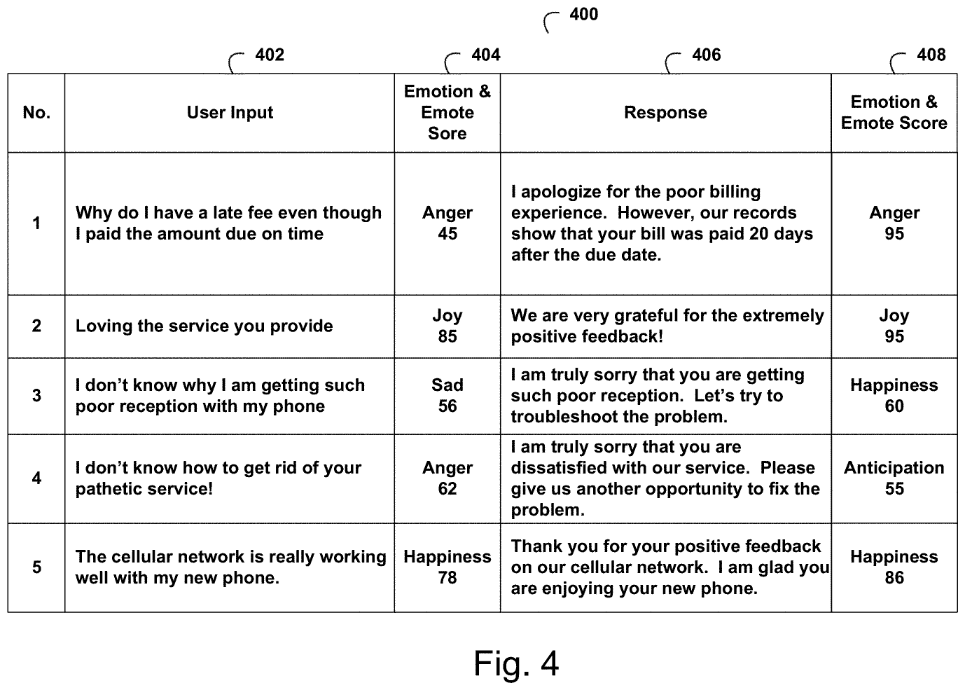

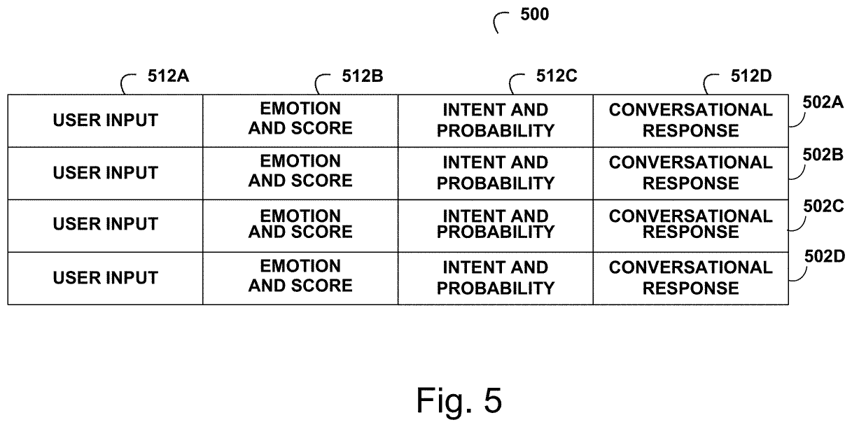

Repeated fallout information can include information indicating incorrect responses to user input. As discussed below in connection with FIGS. 4 and 5, conversation data 208 can be used as feedback for tuning one or more trained machine learning models of conversational response generator 100, such as emotion classifier 108, intent classifier 114 and attention-based neural network model 118.

As shown in the example provided by FIG. 2, data from blocks 212, 214, 216 and 218 can be used as training data input to model training 220 to generate an emotion detection model 222. Model training 220 can use one or more machine learning algorithms using supervised or unsupervised training to train the emotion detection model 222. In accordance with one or more embodiments, emotion detection model 222 can be emotion classifier 108. In accordance with one or more such embodiments, emotion classifier 108 can be trained using supervised learning.

Referring again to FIG. 1, intent intelligence engine 112 can comprise an intent classifier 114 configured to identify an intent and probability 116 using the user input 102. The intent probability can indicate a likelihood of the identified intent. By way of a non-limiting example, a tool such as Dialogflow® provided by Google® or Lex® provided by Amazon® can be used as intent classifier 114. Both tools use supervised machine learning to train a model to identify an intent and probability 116. More particularly, both tools use training phrases as examples of what a user might say and labeling information associated with each training phrase identifying the intent of the training phrase. As an alternative to using these tools, a machine learning algorithm can be used to train a model to identify an intent and probability 116 using a set of training examples. As discussed above, a supervised approach can be used with each training example including labeling information indicating intent.

In accordance with one or more embodiments, user input 102, emotion and emote score 110 and intent and probability 116 can be input to attention-based neural network model 118. Attention-based neural network model 118 can be trained using a machine learning algorithm and training examples. By way of a non-limiting example, supervised learning can be used and each training example can include features representing the user input and an associated response to the user input. The associated response can be used as the labeling information for the supervised learning.

In accordance with one or more embodiments, response 128 can comprise a number of fragments and attention-based neural network model 118 can be trained to identify candidate probabilities for each of a number of fragments of response 128. By way of a non-limiting example, the candidate probabilities include, for each fragment of the number of fragments of response 128, a candidate probability for each of a number of candidates. A candidate for selection in connection with a fragment of response 128 can be a word (or words), a phrase or the like, or a placeholder. As is discussed below, a placeholder can be used to instruct placeholder filler 122 to retrieve data from user and response data 126 and insert the retrieved data into response 128 in place of the placeholder.

In accordance with one or more embodiments, the set of candidates used by attention-based neural network model 118 includes candidates for the number of fragments of response 128, such that each fragment has a set of candidate probabilities for each candidate in the set of candidates. The output of attention-based neural network 118 can be used by sentence generator 120 to select a candidate for a fragment of response 128. In accordance with one or more embodiments, sentence generator 120 can comprise more than one sentence generator.

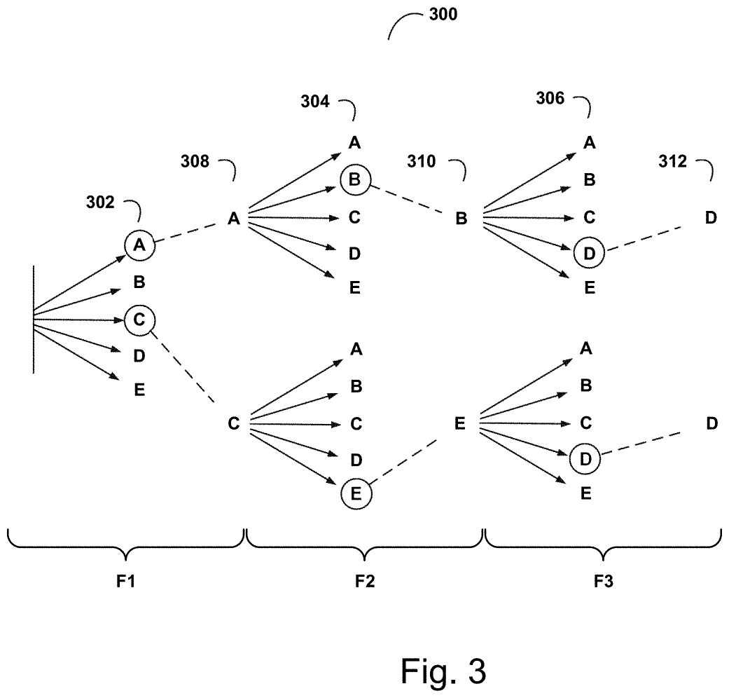

FIG. 3 provides an example illustrating candidate selection in accordance with one or more embodiments of the present disclosure. For the sake of simplicity, a vocabulary of candidates is represented using the letters A, B, C, D and E in example 300 shown in FIG. 3. By way of a non-limiting example, a candidate vocabulary can be identified using historical data comprising user input, responses and placeholders.

In accordance with one or more embodiments, attention-based neural network 118 can output a probability for each candidate in the candidate vocabulary for each fragment of a number of fragments of response 128. For a given fragment of response 128, a candidate's probability represents the likelihood, or suitability, of that candidate for the fragment of response 128. Sentence generator 120 can use the candidate probabilities associated with a fragment to choose a candidate for the fragment. Sentence generator 120 can use an iterative process including a number of iterations. In a first iteration, an initial number of candidates can be selected. In example 300 shown in FIG. 3, the initial number is equal to 2. In each subsequent iteration, sentence generator 120 can cull candidates from the initial number of candidates. In the last iteration, sentence generator 120 can select a candidate for a fragment using the fragment's remaining candidates.

In example 300, fragments F1, F2 and F3 represent the first three fragments of response 128. As discussed, sentence generator 120 can use an iterative process to select a candidate for each one of the fragments F1, F2 and F3 of response 128. In the first iteration, sentence generator 120 can use probabilities associated with each candidate in the candidate vocabulary and the first fragment, F1, to select an initial number of candidates for fragment F1. Each subsequent fragment's candidate selection can be by taking into account the candidate selection made in connection with previous fragment(s). In example 300, the initial number of candidates selected for fragment F2 can take into account fragment F1's candidate selections, and the initial number of candidates selected for fragment F3 can take into account the candidate selections made for fragment F1 and fragment F2.

Example 300 illustrates selections associated with a first iteration of sentence generator 120 in connection with fragments F1, F2 and F3 of response 128. At stage 302, sentence generator 120 can use the candidate probabilities determined for fragment F1 to select an initial number (e.g., 2 in example 300) of candidates for fragment F1. In example 300, A and C are the candidates selected by sentence generator 120 for fragment F1 in the first iteration.

At stage 304, sentence generator 120 selects a set of candidates for fragment F2 of response 128 by taking into account the selection set 308 formed at stage 302 in connection with fragment F1 and the candidate probabilities determined for fragment F2. At stage 304, candidate probabilities can represent the likelihood that the candidate is suitable given the candidate selections made at stage 302 for fragment F1. For example, at stage 304, the probabilities associated with candidates A, B, C, D and E can reflect the selection of candidate A (or candidate C) at stage 302.

Thus, at stage 304, the probability of candidate B following candidate A in response 128 can be the same or different from the probability of candidate B following candidate C in response 128. Sentence generator 120 can use the probabilities associated with each candidate at stage 304 to select a set of candidates for fragment F2 in the first iteration. In example 300, at stage 304, sentence generator 120 makes one candidate selection for each candidate selected at stage 302 for fragment F1. As shown in example 300, selection set 310 shows the candidate selections made by sentence generator 120 for fragment F2 at stage 304. At stage 306, sentence generator 120 selects a set of candidates for fragment F3 of response 128 using the candidate selection sets 308 and 310 from stages 302 and 304 in connection with fragments F1 and F2 (respectively). As shown in example 300, selection set 312 includes candidate D selected in accordance with each candidate selection made in each prior stage in an iteration of sentence generator 120.

The sentence generator 120 can continue in this manner to make selections for each fragment of the number of fragments of response 128 until each fragment has a corresponding set of candidates at the end of the first iteration.

In subsequent iterations, sentence generator 120 can cull one or more candidates from a fragment's set of candidates. As with the first iteration, candidate culling for a subsequent fragment can take into account the candidate culling made in connection with the fragment(s) previously processed by the sentence generator 120 in the current iteration.

The iterative process can continue until sentence generator 120 has selected a candidate for each fragment of the number of fragments of response 128. In example 300, a second iteration can be used to cull candidates from a fragment's set of candidates. By way of a non-limiting example, in the second iteration, assuming candidate A is selected for fragment F1 (and candidate C is culled from fragment F1's selection set 308), candidate B can be selected for fragment F2 (and candidate E is culled from fragment F2's selection set 310) and candidate D can be selected for fragment F3.

In accordance with one or more embodiments, a candidate selected by sentence generator 120 for a fragment of response 128 can be a placeholder. Referring again to FIG. 1, placeholder filler 122 can replace the placeholder with data, such as user data stored in user and response data 126. A placeholder can include information that the placeholder filler 122 can use to identify and retrieve the data to use to replace the placeholder. For example, the placeholder can identify the data item (e.g., user name, account number, account balance, billing information, etc.) from the user and response data 126 to use as a replacement for the placeholder.

In accordance with one or more embodiments, conversational response generator 100 can include a response selector 124 which can be configured to determine whether to add mediatory content to the response 128 generated by the conversational response generator 100. Examples of mediatory content that can be selected by response selector 124 include making a suggestion to transfer the user to a live agent, provide one or more offers (e.g., coupon, gift or the like), etc. In the case where the response selector 124 makes a determination to add mediatory content to response 128, the response 128 including the mediatory content can be provided by conversational response generator 100 (e.g., via response selector 124), so that it can be displayed in conversational user interface 104. As discussed, conversational user interface 104 can be displayed on a display at the user's computing device in response to the user input 102.

In accordance with one or more embodiments, the response selector 124 can be configured to replace the response 128 generated by conversational response generator 100 with mediatory content, such that the mediatory content is displayed as response 128 in place of the response generated by the conversational response generator 100.

FIG. 4 provides examples of user input and response combinations in accordance with one or more embodiments of the present disclosure. Example 400 includes five rows numbered 1-5. Each row includes an example of user input 102 in column 402 and a corresponding response 128 in column 406 In addition, each row includes examples of emotions (in columns 404 and 408). The emotions listed in columns 404 and 408 are examples of emotions that can be generated by emotion classifier 108. Emotions shown in column 404 can be generated using user input in column 402 and emotions shown in column 408 can be generated using user input following responses in column 406.

By way of a further illustration, the first row in example 400 includes user input in column 402 and an example of a user emotion (e.g., “anger”) that can be generated using the user input. The corresponding text in column 408 provides an example of a conversational response that can be generated by conversational response generator 100 using the user input in column 402 and the emotion in column 404.

In example 300, the response in column 408 and row 1 includes data filled in by placeholder filler 122. More particularly, the response includes information about the user account billing information including the data indicating that the user's bill was paid 20 days after payment was due.

In accordance with one or more embodiments, response selector 124 can be configured to identify a negative user emotion and attempt to provide mediatory content (e.g., offer to connect the user to a live agent, provide one, more offers or the like) likely to improve the user emotion. As discussed, the response selector 124 can elect to override or augment the response generated by conversational response generator 100 prior to communicating the response to the user via the conversational user interface 104.

By way of a non-limiting example, the emotion in column 408 of row 1 indicates that the user emotion following the response (in column 408 of row 1) did not change the user's emotion, but the emote score went from 45 before the response to 95 after the response. Given that the user emotion (“anger”) is a negative (or undesirable) emotion, response selector 124 can choose to provide mediatory content. As discussed, response selector 124 can choose to add the mediatory content to the response generated by the conversational response generator 100. In row 1 of example 400, the response selector can be configured to make a determination to add mediatory content (e.g., “Would you like to speak to a live agent?”) to the end of the response shown in 406.

By way of a non-limiting example, the response selector 124 can use the emotion shown in column 408 alone or in combination with the emote score and a threshold emote score to make a determination whether or not to use mediatory content in response 128. In row 1 of example 400, the emote score associated with the “anger” emotion can be compared to the threshold emote score to determine whether the intensity of the emotion is significant enough for the response selector 124 to provide mediatory content.

By way of a further non-limiting example, assuming that the emote score threshold is set at 75, the intensity of the user's anger (as indicated by the emote score of 45) in column 404 of row 1 in example 400 does not satisfy the threshold. As such, the response selector 124 can be configured to determine to not add any mediatory content to the response 128. The emote score corresponding to the “anger” emotion shown in row 1 and column 408 does satisfy the emote score threshold of 75 indicating that the intensity of the user's anger is significant enough to warrant some type of mediatory content. By way of another non-limiting example, an emote score range can be used in determining whether or not to use mediatory content in connection with response 128. As discussed, the response selector 124 can replace the response with mediatory content or add the mediatory content to the response generated by the conversational response generator 100.

Row 2 of example 400 illustrates a case in which the user emotion is a desirable user emotion, “joy,” and a corresponding emote score of 85 determined by the emotion classifier 108 using the user input shown in column 402 of row 2. The response selector 124 can make a determination that the emotion is a positive (or desirable) emotion with significant intensity and choose to use the response generated by the conversational response generator 100 as the response 128 displayed via conversational user interface 104. A similar approach can be used by response selector 124 in the example in row 5, which indicates that the user is “happy” and that the positive emotion has a corresponding strong intensity before and after the response in row 5, column 406.

Rows 3 and 4 provide examples of negative (undesirable) emotions in column 402. In both examples, the intensity of the negative user emotion does not satisfy a threshold emote score level of 75. In both examples, since the threshold emote score is not satisfied, the response selector 124 can choose to use the response 128 generated by the conversational response generator 100 (e.g., the response shown in column 406 of rows 3 and 4). That is, the response selector 124 can choose to use the response generated by conversational response generator 100 (which may or may not include user data inserted by placeholder filler 122) as the output of conversational response generator 100 for display by conversational user interface 104. In both cases, the user emotion changes from a negative one to a positive emotion with an acceptable level of intensity after the respective responses.

In accordance with one or more embodiments, the emotions shown in columns 404 and 408 of a given row can be used along with the user input and response in columns 402 and 406 of the row as feedback to tune one or more trained machine learning models of the conversational response generator 100. For example, the user input and response and corresponding emotions, emotion scores, intents and intent probabilities can be used as feedback to tune one or more trained machine learning models of the conversational response generator 100, including the emotion classifier 108, intent classifier 114, attention-based neural network model 118.

FIG. 5 provides an example of conversation data that can be used in tuning conversational response generator 100 in accordance with one or more embodiments. In example 500, rows 502A-502D each include a pairing of a user input (e.g., user input 102) in column 512A and a conversational response in row 512D. The conversational response can be response 128 generated by conversational response generator 100 using the user input in column 512A. In example 500, the user input in rows 502B-502D is received after the conversational response in the preceding row(s), e.g., the user input in 502B is received after the conversational response in row 502A, etc.

In accordance with one or more embodiments, the emotion and score determined using the user input following a response 128 can be used in determining the effectiveness of the response 128. By way of illustration, the user input in row 502B can be used to determine the emotion and score in row 502B, and the emotion and score in rows 502A and 502B can be compared to determine whether or not the response in row 502A was effective (e.g., resulted in a positive change in the user's emotion) or ineffective (e.g., resulted in a negative change in the user's emotion).

By way of further illustration, a change from a desirable emotion (e.g., “happy”) to a negative emotion (e.g., “angry”) can be a negative change. The score associated with an emotion can be used as an indicator of a strength of, or confidence in, the emotion. The strength of the emotion can change after a response 128. If the strength of the emotion decreases and the emotion is a desirable emotion, this information can be used as a measure of the effectiveness of the response 128.

As yet another example, if the emotion is unchanged but the strength of the emotion decreases, the conversational response can be considered to be effective to some degree. However, the effectiveness can be considered to be less effective than a response 128 in which a subsequent emotion is changed from an undesirable to a desirable emotion.

In accordance with one or more embodiments, one or more training examples can be generated by the conversational response generator 100 as feedback to tune a trained attention-based neural network model 118. Each training example can include the user input, emotion and score data, and the response 128 corresponding to the user input. By way of a non-limiting example, the response 128 can be a label with a supervised learning approach for tuning trained attention-based neural network model 118. In addition, each training example can include the emotion and score generated using the user input and the emotion and score generated using the user input following the conversational response.

In accordance with one or more embodiments, the emotion and score shown in column 512B of example 500 can be used to generate training examples used as feedback to tune emotion classifier 114. By way of a non-limiting example, the user input 102 can be used to generate a training example that includes, as a label for the training example, the emotion and emote score identified by the emotion classifier 114 using the user input.

In accordance with one or more embodiments, a user's intent is likely to remain constant during a conversation. If the user's intent changes during the conversation, this can indicate that the initial determination made by intent classifier 114 was incorrect. In example 500, each intent and probability in column 512C can be an intent and probability 116 output by intent classifier 114 in connection with one conversation. If the intent does change during the conversation, the user's intent is likely to be established by intent classifier 114 at some point during the conversation. One or more training examples can be generated using the established intent as a label for the user input, and the training example(s) can be used as feedback to further train, or tune, the intent classifier 114, such that the ability of the intent classifier 114 to identify the intent can be improved.

In accordance with one or more embodiments, a change in intent during a conversation can indicate that an undesirable change in emotion and emotion score was at least partially based on the change in intent determined by the intent classifier 114. This information can be included in the training data used in tuning the attention-based neural network model 118. By way of a non-limiting example, the change in intent can be used as a possible reason (rather than the response 128) for the undesirable change in emotion and emotion score.

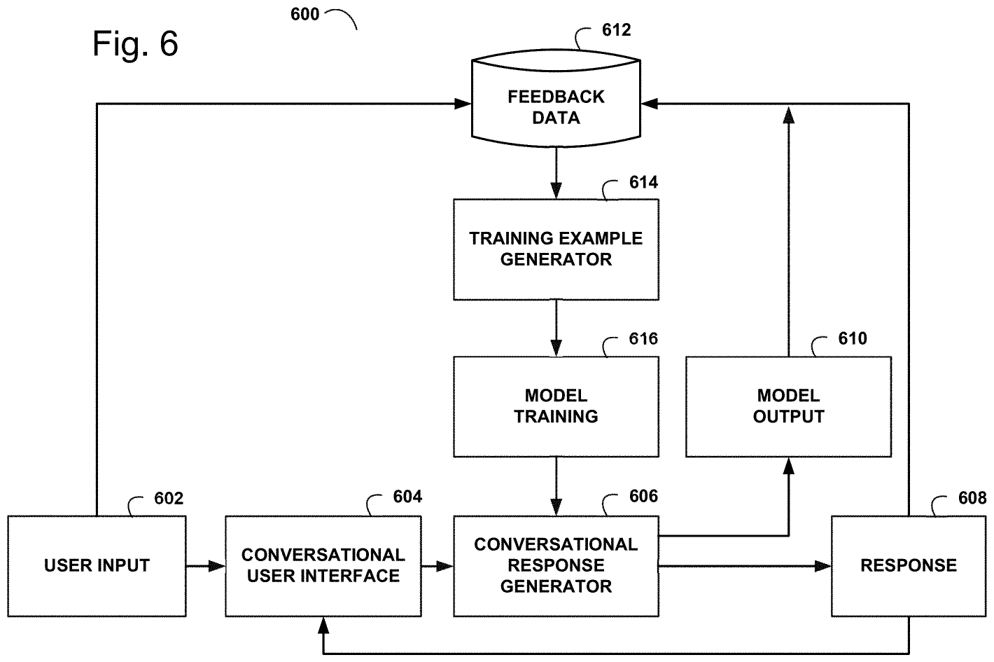

FIG. 6 provides an example illustrating feedback used in tuning conversational response generator 100 in accordance with one or more embodiments of the present disclosure. In example 600, conversational response generator 606 receives user input 602 via conversational user interface 604 and can generate a response 608 using the user input 602 as described herein. In example 600, conversational response generator 606 can store user input 602, model output 610 and response 608 in feedback data 612. The model output 610 can include emotion and emote score 110, intent and probability 116 and the candidate probabilities output by attention-based neural network model 118 in connection with each fragment of the number of fragments of response 608.

With reference to FIG. 5, conversational response generator 606 can store information identifying the session, user and information for each user input and response pairing and information identifying a sequence or order of each user input and response pairing. By way of a non-limiting example, the ordering can indicate that the user input and conversational response in row 502A is the first pairing followed by the user input and conversational response pairings in rows 502B-502D. The information for each user input and response pairing can include the corresponding user emotion and emote score 110 and user intent and probability 116.

In accordance with one or more embodiments, the stored information can be used by training example generator 614 to generate training examples used by model training 616 to tune one or more models of conversational response generator 606 (e.g., conversational response generator 100).

As discussed in connection with FIG. 5, the emotion and emote score 110 determined using the user input following a response 128 can be used in determining the effectiveness of the response 128. As discussed, negative changes can include a change from a desirable emotion (e.g., “happy”) to a negative emotion (e.g., “angry”) and/or an undesirable change in emote score (e.g., a decrease in a desirable emotion's score or an increase in an undesirable emotion's score) can indicate a negative change.

In accordance with one or more embodiments, one or more training examples can be generated by the training example generator 614 as feedback to tune the trained attention-based neural network model 118. Each training example can include the user input 102, emotion and emote score 110, intent and probability 116, and the response 128. The response 128 can be a label in a supervised learning process for tuning the trained attention-based neural network model 118. In addition, each training example can include the emotion and emote score 110 generated using the user input 102 following the response 128.

In accordance with one or more embodiments, a change in intent during a conversation can indicate that an undesirable change in emotion and emotion score was at least partially based on the change in intent determined by the intent classifier 114. This information can be included in the training data generated by training example generator 614 and used in tuning the attention-based neural network model 118.

In accordance with one or more embodiments, the training example generator 614 can use the emotion and emote score 110 associated with a user input 102 to generate training examples used as feedback to turn emotion classifier 114.

In example 600, a change in a user's intent changes during a conversation can indicate that the initial determination made by intent classifier 114 was incorrect. One or more training examples can be generated by training example generator 614 using the intent and probability 116 established during the conversation as the correct intent and probability 116 as a training example label. By way of a non-limiting example, each training example can include the established intent as a label for each user input in the example, and the training example(s) can be used as feedback to tune the trained intent classifier 114.

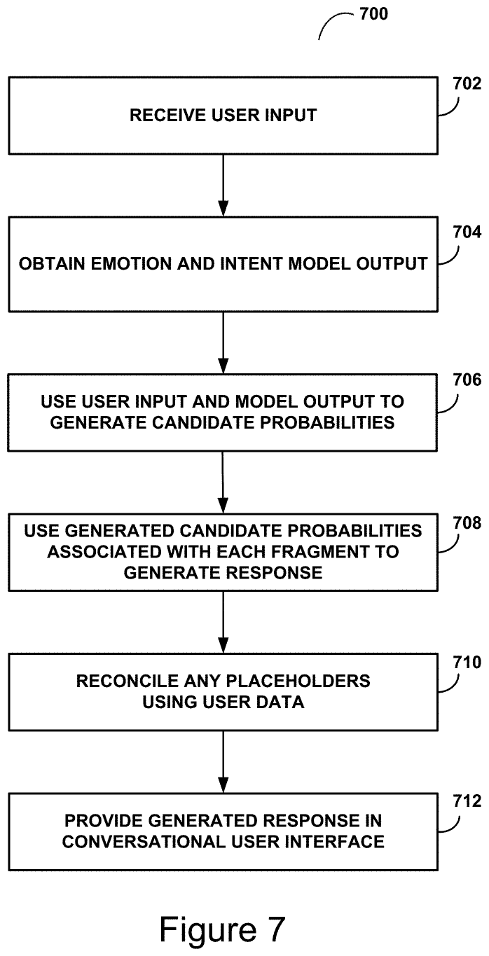

FIG. 7 provides an example of a conversational response generation process flow used in accordance with one or more embodiments of the present disclosure. The conversation response generation process flow 700 can be performed by conversational response generator 100 (or conversational response generator 606) in response to user input 102.

Process flow 700 can be invoked in response to user input 102 provided via a conversational user interface 104 of a software application, such as a chatbot. The software application can be a component of, or be a component used by, a dialogue system and can use one or more modes of communication (e.g., text, speech, graphics, haptics, gestures) for input and output channels. By way of a non-limiting example, conversational user interface 104 can provide the input and output channels.

In accordance with one or more embodiments, the conversational response generator 100 can be used to generate a response 128 as a reply to user input 102 in any of a number of use cases, such as and without limitation customer service, information gathering, intelligent virtual assistant or the like. In accordance with one or more embodiments, the conversational response generator 100 can perform process flow 700 in connection with a mobile application, a web application, desktop application, etc.

At step 702 of process 700, user input is received. By way of a non-limiting example, user input can be user input 102 received by conversational response generator 100 (e.g., via conversational user interface 104). At step 704. emotion and intent model output can be obtained. By way of a non-limiting example, the user input 102 received at step 702 can be used to obtain emotion and emote score 110 and intent and probability 116. As discussed herein, the emotion and emote score 110 can be obtained from emotion classifier of emotional intelligence engine 106 using user input 102, and an intent and probability 116 can be obtained from intent classifier 114 of intent intelligence engine 112 using user input 102.

At step 706 of process 700, the user input and model output can be used to generate candidate probabilities. As discussed herein in connection with one or more embodiments, a response 128 can comprise a number of fragments. By way of a non-limiting example, a trained machine learning model (e.g., attention-based neural network model 118) can be used to identify, for a fragment of response 128, a set of candidate probabilities comprising a probability for each candidate of a vocabulary used in generating response 128.

In accordance with one or more embodiments, a candidate can be one or a number of candidates of a vocabulary used in generating a response 128. By way of a non-limiting example, a vocabulary can comprise words, phrases, placeholders or the like. By way of a non-limiting example, a candidate vocabulary can be identified using historical data comprising user input, responses and placeholders. By way of some non-limiting examples, each candidate included in a candidate vocabulary can comprise a word, a set of words, etc. or a placeholder. A candidate from the vocabulary can be selected for each fragment of the number of fragments of the response 128. In accordance with one or more embodiments, attention-based neural network model 118 can output, for a fragment of a response 128, an associated probability for each candidate in the vocabulary used in generating response 128.

In accordance with one or more embodiments, a candidate for selection in connection with a fragment of response 128 can be a placeholder. As is discussed herein, a placeholder can be used to instruct placeholder filler 122 to retrieve data from user and response data 126 and insert the retrieved data into response 128.

At step 708, the generated candidate probabilities associated with each fragment of the number of fragments can be used to generate a response. By way of a non-limiting example, the output of attention-based neural network model 118 can include candidate probabilities associated with each fragment of response 128, and the output can be used by sentence generator 120 to select a candidate for each fragment of response 128. In accordance with one or more embodiments, a fragment's associated candidate probabilities output by attention-based neural network model 118 can include a probability for each candidate in the candidate vocabulary. For a given fragment of response 128, a candidate's probability represents the likelihood, or suitability, of that candidate for the fragment of response 128. The attention-based neural network model 118 can output candidate probabilities corresponding to each fragment of response 128.

In accordance with one or more embodiments, sentence generator 120 can use an iterative process described herein in connection with FIG. 3 and example 300 to select a candidate for each fragment of response 128. In accordance with one or more embodiments, a candidate selected by sentence generator 120 for a fragment of response 128 can be a placeholder.

Referring again to FIG. 7, any placeholders can be reconciled using user data at step 710. In accordance with one or more embodiments, placeholder filler 122 can replace each placeholder with data, such as user data stored in user and response data 126. A placeholder can include information that the placeholder filler 122 can use to identify and retrieve the data to use to replace the placeholder. For example, the placeholder can identify the data item (e.g., user name, account number, account balance, etc.) from the user and response data 126 to use as a replacement for the placeholder.

At step 712, the generated response can be provided in a conversational user interface. By way of a non-limiting example, the generated response can be response 128, which can be provided to a user via conversational user interface 104 in reply to user input 102 received from the user via conversational user interface 104.

In accordance with one or more embodiments, process 700 can further include steps of training and tuning the conversational response generator 100 using training data obtained from one or more of sources 202, 204, 206 and 208. The training data can be generated using data illustrated in blocks 212, 214, 216 and 218. Once trained, conversational response generator 100 can use user input 102 to generate emotion and emote score 110 and intent and probability 116, which can be used with the user input 102 (by attention-based neural network 118) to generate candidate probabilities for each fragment of the number of fragments of response 128. The sentence generator 120 can use the candidate probabilities associated with a fragment to select a candidate for the fragment, and placeholder filler 122 can identify and replace each placeholder with data from user and response data 126.

As described herein in connection with one or more embodiments, the user input 102, response 128 and associated emotion and emote score 110 and intent and probability 116 can be saved and used as feedback for tuning one or more trained machine learning models of conversational response generator 100.

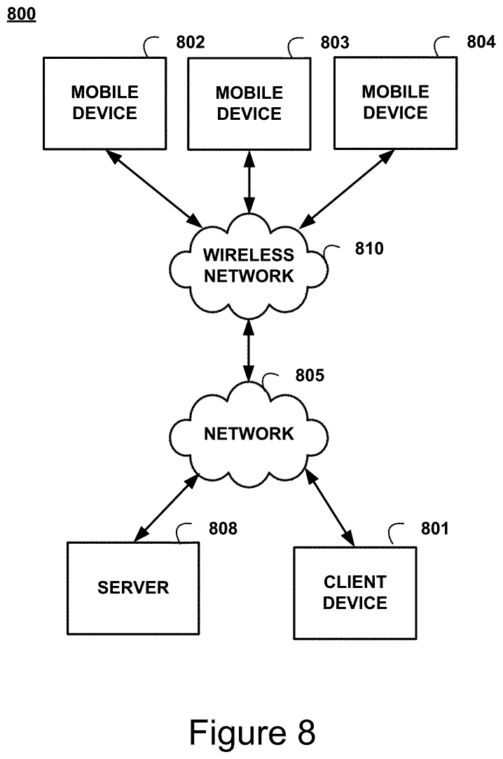

FIG. 8 provides an example of components of a general environment in accordance with one or more embodiments. FIG. 8 shows components of a general environment in which the systems and methods discussed herein may be practiced. Not all the components may be required to practice the disclosure, and variations in the arrangement and type of the components may be made without departing from the spirit or scope of the disclosure. As shown, system 800 of FIG. 8 includes local area networks (“LANs”)/wide area networks (“WANs”)—network 805, wireless network 810, mobile devices (client devices) 802-804 and client device 801. FIG. 8 additionally includes a server 808. Examples of web servers include without limitation, application servers, content servers, search servers, advertising servers, etc.

In accordance with one or more embodiments, server 808 can include functionality disclosed herein in connection with one or more embodiments. Server 808 can host one or more web applications, for which user reaction is being monitored.

One embodiment of mobile devices 802-804 is described in more detail below. Generally, however, mobile devices 802-804 may include virtually any portable computing device capable of receiving and sending a message over a network, such as network 805, wireless network 810, or the like. Mobile devices 802-804 may also be described generally as client devices that are configured to be portable. Thus, mobile devices 802-804 may include virtually any portable computing device capable of connecting to another computing device and receiving information. Such devices include multi-touch and portable devices such as, cellular telephones, smart phones, radio frequency (RF) devices, infrared (IR) devices, Personal Digital Assistants (PDAs), handheld computers, laptop computers, wearable computers, smart watch, tablet computers, phablets, integrated devices combining one or more of the preceding devices, and the like.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 802-804 also may include at least one client application that is configured to receive content from another computing device. The client application may include a capability to provide and receive textual content, graphical content, audio content, and the like. In one embodiment, mobile devices 802-804 may uniquely identify themselves through any of a variety of mechanisms, including a phone number, Mobile Identification Number (MIN), an electronic serial number (ESN), or other mobile device identifier.

In some embodiments, mobile devices 802-804 may also communicate with non-mobile client devices, such as client device 801, or the like. Client device 801 may include virtually any computing device capable of communicating over a network to send and receive information. Thus, client device 801 may also have differing capabilities for displaying navigable views of information.

Client device 801 and mobile devices 801-804 may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 810 is configured to couple mobile devices 802-804 and its components with network 805. Wireless network 810 may include any of a variety of wireless sub-networks that may further overlay stand-alone ad-hoc networks, and the like, to provide an infrastructure-oriented connection for mobile devices 802-804. Such sub-networks may include mesh networks, Wireless LAN (WLAN) networks, cellular networks, and the like.

Network 805 is configured to communicatively couple web server 808 with other computing devices, including, client device 801, and through wireless network 810 to mobile devices 802-804. Network 805 is enabled to employ any form of computer readable media for communicating information from one electronic device to another. Also, network 805 can include the Internet in addition to local area networks (LANs), wide area networks (WANs), direct connections, such as through a universal serial bus (USB) port, other forms of computer-readable media, or any combination thereof.

Within the communications networks utilized or understood to be applicable to the present disclosure, such networks will employ various protocols that are used for communication over the network. Signaling formats or protocols employed may include, for example, TCP/IP, UDP, QUIC (Quick UDP Internet Connection), DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs.

A server, such as server 808, may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like.

In some embodiments, users are able to access services provided by servers, such as web server 808 as well as other servers, such as and without limitation authentication servers, search servers, email servers, social networking services servers, SMS servers, IM servers, MMS servers, exchange servers, photo-sharing services servers, and travel services servers, via the network 805 using their various devices 801-804. In some embodiments, application server can host applications, such as an e-commerce application, a search engine, a content recommendation and/or distribution application, etc.

In some embodiments, web server 808 can store various types of applications and application related information including application data. As is discussed in more detail below, examples of application data include user behavior, application behavior, page visitation sequences, and visit intent and action data. In accordance with some embodiments, web server 808 can host an application, or applications, embodying functionality described herein.

Moreover, although FIG. 8 illustrates web server 808 as single computing devices, respectively, the disclosure is not so limited. For example, one or more functions of web server 808 may be distributed across one or more distinct computing devices. Moreover, in one embodiment, web server 808 may be integrated into a single computing device, without departing from the scope of the present disclosure.

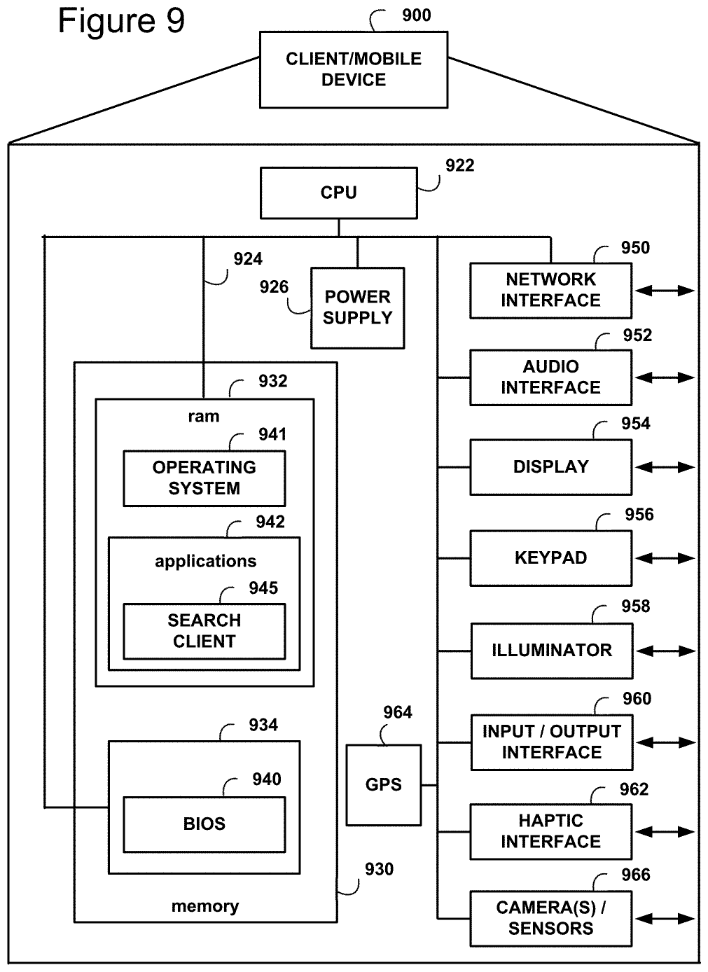

FIG. 9 is a schematic diagram illustrating an example embodiment of a computing device that may be used within the present disclosure. Device 900 may include many more or less components than those shown in FIG. 9. However, the components shown are sufficient to disclose an illustrative embodiment for implementing the present disclosure. Device 900 may represent, for example, client device 801 and mobile devices 801-804 discussed above in relation to FIG. 8.

As shown in the figure, device 900 includes a processing unit (CPU) 922 in communication with a mass memory 930 via a bus 924. Device 900 also includes a power supply 926, one or more network interfaces 950, an audio interface 952, a display 954, a keypad 956, an illuminator 958, an input/output interface 960, a haptic interface 962, an optional global positioning systems (GPS) receiver 964 and a camera(s) or other optical, thermal or electromagnetic sensors 966. Device 900 can include one camera/sensor 966, or a plurality of cameras/sensors 966, as understood by those of skill in the art. The positioning of the camera(s)/sensor(s) 966 on device 900 can change per device 900 model, per device 900 capabilities, and the like, or some combination thereof.

Optional GPS transceiver 964 can determine the physical coordinates of device 900 on the surface of the Earth, which typically outputs a location as latitude and longitude values. GPS transceiver 964 can also employ other geo-positioning mechanisms, including, but not limited to, triangulation, assisted GPS (AGPS), E-OTD, CI, SAI, ETA, BSS or the like, or may through other components, provide other information that may be employed to determine a physical location of the device, including for example, a MAC address, Internet Protocol (IP) address, or the like.

Mass memory 930 includes a RAM 932, a ROM 934, and other storage means. Mass memory 930 illustrates another example of computer storage media for storage of information such as computer readable instructions, data structures, program modules or other data. Mass memory 930 stores a basic input/output system (“BIOS”) 940 for controlling low-level operation of device 900. The mass memory also stores an operating system 941 for controlling the operation of device 900.

Memory 930 further includes one or more data stores, which can be utilized by device 900 to store, among other things, applications 942 and/or other data. For example, data stores may be employed to store information that describes various capabilities of device 900. The information may then be provided to another device based on any of a variety of events, including being sent as part of a header during a communication, sent upon request, or the like.

Applications 942 may include computer executable instructions which, when executed by device 900, transmit, receive, and/or otherwise process audio, video, images, and enable telecommunication with a server and/or another user of another client device. Other examples of application programs or “apps” in some embodiments include browsers, calendars, contact managers, task managers, transcoders, photo management, database programs, word processing programs, security applications, spreadsheet programs, games, search programs, and so forth. Applications 942 may further include search client 945 that is configured to send, to receive, and/or to otherwise process a search query and/or search result using any known or to be known communication protocols. Although a single search client 945 is illustrated it should be clear that multiple search clients may be employed.

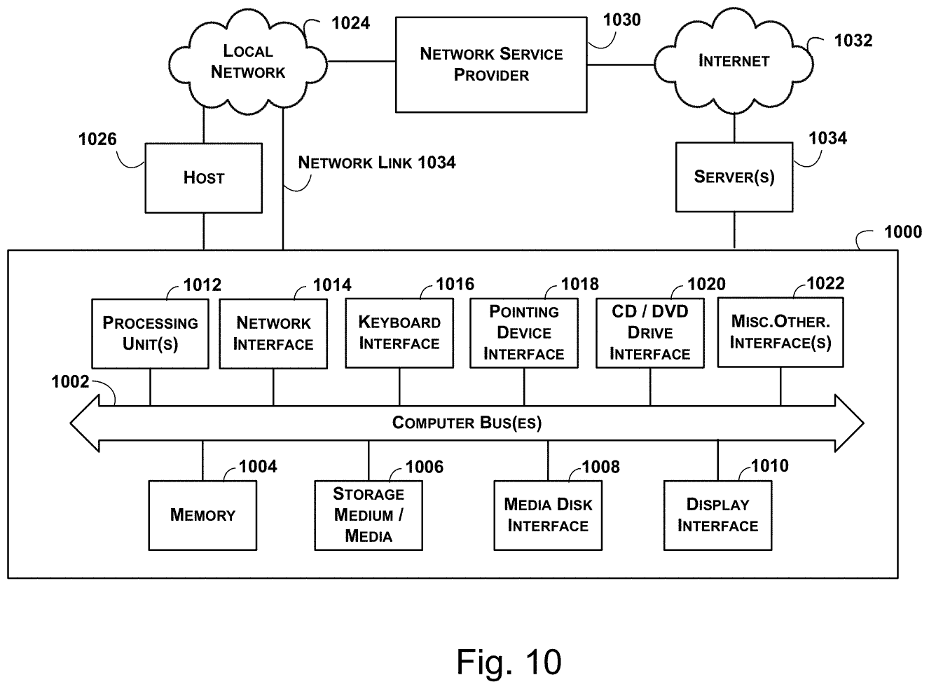

As shown in FIG. 10, internal architecture 1000 of a computing device(s), computing system, computing platform, user devices, set-top box, smart TV and the like includes one or more processing units, processors, or processing cores, (also referred to herein as CPUs) 1012, which interface with at least one computer bus 1002. Also interfacing with computer bus 1002 are computer-readable medium, or media, 1006, media disk interface 1008, network interface 1014, memory 1004, e.g., random access memory (RAM), run-time transient memory, read only memory (ROM), media disk drive interface 1020 as an interface for a drive that can read and/or write to media, display interface 1010 as interface for a monitor or other display device, keyboard interface 1016 as interface for a keyboard, pointing device interface 1018 as an interface for a mouse or other pointing device, and miscellaneous other interfaces 1022 not shown individually, such as parallel and serial port interfaces and a universal serial bus (USB) interface.

Memory 1004 interfaces with computer bus 1002 so as to provide information stored in memory 1004 to CPU 1012 during execution of software programs such as an operating system, application programs, device drivers, and software modules that comprise program code, and/or computer executable process steps, incorporating functionality described herein, e.g., one or more of process flows described herein. CPU 1012 first loads computer executable process steps from storage, e.g., memory 1004, computer readable storage medium/media 1006, removable media drive, and/or other storage device. CPU 1012 can then execute the stored process steps in order to execute the loaded computer-executable process steps. Stored data, e.g., data stored by a storage device, can be accessed by CPU 1012 during the execution of computer-executable process steps.

Persistent storage, e.g., medium/media 1006, can be used to store an operating system and one or more application programs. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 1034 typically provides information communication using transmission media through one or more networks to other devices that use or process the information. For example, network link 1034 may provide a connection through local network 1024 to a host computer 1026 or to equipment operated by a Network or Internet Service Provider (ISP) 1030. ISP equipment in turn provides data communication services through the public, worldwide packet-switching communication network of networks now commonly referred to as the Internet 1032.

A computer called a server 1036 connected to the Internet 1032 hosts a process that provides a service in response to information received over the Internet 1032. For example, server 1036 can host a process that provides information representing video data for presentation at a display via display interface 1010. It is contemplated that the components of system 1000 can be deployed in various configurations within other computer systems, e.g., host and server.

At least some embodiments of the present disclosure are related to the use of computer system 1000 for implementing some or all of the techniques described herein. According to one embodiment, those techniques are performed by computer system 1000 in response to processing unit 1012 executing one or more sequences of one or more processor instructions contained in memory 1004. Such instructions, also called computer instructions, software and program code, may be read into memory 1004 from another computer-readable medium 1006 such as a storage device or network link. Execution of the sequences of instructions contained in memory 1004 causes processing unit 1012 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 1000. Computer system 1000 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 1012 as it is received, or may be stored in memory 1004 or in a storage device or other non-volatile storage for later execution, or both.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media can tangibly encode computer-executable instructions that when executed by a processor associated with a computing device perform functionality disclosed herein in connection with one or more embodiments.

Computer-readable storage media includes, but is not limited to, RAM, ROM, EPROM, EEPROM, flash memory or other solid-state memory technology, CD-ROM, DVD, or other optical storage, cloud storage, magnetic storage devices, or any other physical or material medium which can be used to tangibly store thereon the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
obtaining, by a computing device, user input from a user via a conversational user interface of an application;
obtaining, by the computing device, a user emotion and user intent using the user input;
obtaining, by the computing device, candidate probabilities for a fragment of a response to the user input using the obtained user emotion, the obtained user intent and the user input, a candidate probability associated with the fragment indicating a suitability of the candidate for the fragment;
selecting, by the computing device, a candidate from a number of candidates for the fragment using the candidate probabilities obtained for the fragment;
generating, by the computing device, the response using the candidate selected for the fragment; and
communicating, by the computing device, the response to the user via the conversational user interface of the application.

2. The method of claim 1, further comprising:
for each of multiple fragments of the response, the computing device, iteratively obtaining candidate probabilities and selecting a candidate from the number of candidates using the candidate probabilities; and
generating the response further comprising assembling the response using the candidate selected for each fragment.

3. The method of claim 1, obtaining a user emotion further comprising:
providing, by the computing device, the user input to a trained emotion classifier and receiving the user emotion and an emote score as output from the trained emotion classifier, the emote score representing an intensity of the user emotion;
providing, by the computing device, the user input to a trained intent classifier and receiving the user intent and an intent probability as output from the trained emotion classifier, the intent probability representing a likelihood of the user intent; and
obtaining, by the computing device, the candidate probabilities for the fragment of the response to the user input using the user emotion, emote score, user intent, intent probability and user input.

4. The method of claim 3, obtaining the candidate probabilities for the fragment of the response further comprising:
providing, by the computing device, the user emotion, emote score, user intent, intent probability and user input to a trained attention-based neural network model and receiving the candidate probabilities for the fragment of the response as output from the trained attention-based neural network model.

5. The method of claim 4, wherein the trained emotion classifier, intent classifier and attention-based neural network model are components of a conversational response generator executed by the computing device.

6. The method of claim 5, further comprising tuning the conversational response generator using a number of user input and response pairings, each user input and response pairing comprising user input received by the conversational response generator and a response generated by the conversation response generator as a reply, each user input and response pairing further comprising the emotion, emote score, intent and intent probability generated using the user input of the pairing.

7. The method of claim 3, further comprising generating the trained emotion classifier using training examples from one or more data sources selected from the following: user interaction data, audio data, video data, user value data and conversation data.

8. The method of claim 1, selecting a candidate for the fragment further comprising:
selecting, by the computing device, a placeholder as the candidate from the number of candidates for the fragment.

9. The method of claim 8, further comprising reconciling, by the computing device, the placeholder, the reconciling comprising replacing the placeholder with user data in the response.

10. The method of claim 1, generating the response to the user input further comprising:
making, by the computing device, a determination to change the response prior to communicating the response to the user, the determination comprising:
identifying the emotion as a negative emotion; and
determining that an intensity of the negative emotion satisfies a threshold intensity level; and
changing, by the computing device, the response to the user input prior to communicating the response based on the determination.

11. The method of claim 10, changing the response comprising selecting from one of the following: adding mediatory content to the response prior to communicating the response to the user via the conversational user interface of the application, or replacing the response with mediatory content prior to communicating the response to the user via the conversational user interface of the application.

12. The method of claim 11, the mediatory content comprising selecting from one of the following: making a suggestion to transfer the user to a live agent, or providing one or more offers.

13. A non-transitory computer-readable storage medium tangibly encoded with computer-executable instructions that when executed by a processor associated with a computing device perform a method comprising:
obtaining user input from a user via a conversational user interface of an application;
obtaining a user emotion and user intent using the user input;
obtaining candidate probabilities for a fragment of a response to the user input using the obtained user emotion, the obtained user intent and the user input, a candidate probability associated with a fragment indicating a suitability of the candidate for the fragment;
selecting a candidate from a number of candidates for the fragment using the candidate probabilities obtained for the fragment;
generating the response using the candidate selected for the fragment; and
communicating the response to the user via the conversational user interface of the application.

14. The non-transitory computer-readable storage medium of claim 13, the method further comprising:
for each of multiple fragments of the response, iteratively obtaining candidate probabilities and selecting a candidate from the number of candidates using the candidate probabilities; and
generating the response further comprising assembling the response using the candidate selected for each fragment.

15. The non-transitory computer-readable storage medium of claim 13, obtaining a user emotion further comprising:
providing the user input to a trained emotion classifier and receiving the user emotion and an emote score as output from the trained emotion classifier, the emote score representing an intensity of the user emotion;
providing the user input to a trained intent classifier and receiving the user intent and an intent probability as output from the trained emotion classifier, the intent probability representing a likelihood of the user intent; and
obtaining the candidate probabilities for a fragment of the response to the user input using the user emotion, emote score, user intent, intent probability and user input.

16. The non-transitory computer-readable storage medium of claim 14, obtaining the candidate probabilities for the fragment of the response further comprising:
providing the user emotion, emote score, user intent, intent probability and user input to a trained attention-based neural network model and receiving the candidate probabilities for the fragment of the response as output from the trained attention-based neural network model.

17. A computing device comprising:
a processor, configured to:
obtain user input from a user via a conversational user interface of an application;
obtain a user emotion and user intent using the user input;
obtain candidate probabilities for a fragment of a response to the user input using the obtained user emotion, the obtained user intent and the user input, a candidate probability associated with the fragment indicating a suitability of the candidate for the fragment;
select a candidate from a number of candidates for the fragment using the candidate probabilities obtained for the fragment;
generate the response using the candidate selected for the fragment; and
communicate the response to the user via the conversational user interface of the application.

18. The computing device of claim 17, the processor further configured to:
for each of multiple fragments of the response, iteratively obtain candidate probabilities and select a candidate from the number of candidates using the candidate probabilities; and
generate the response further comprising assemble the response using the candidate selected for each fragment.

19. The computing device of claim 17, obtaining a user emotion further comprising:
providing the user input to a trained emotion classifier and receiving the user emotion and an emote score as output from the trained emotion classifier, the emote score representing an intensity of the user emotion;
providing the user input to a trained intent classifier and receiving the user intent and an intent probability as output from the trained emotion classifier, the intent probability representing a likelihood of the user intent; and
obtaining the candidate probabilities for the fragment of the response to the user input using the user emotion, emote score, user intent, intent probability and user input.

20. The computing device of claim 18, obtaining the candidate probabilities for the fragment of the response further comprising:
providing the user emotion, emote score, user intent, intent probability and user input to a trained attention-based neural network model and receiving the candidate probabilities for the fragment of the response as output from the trained attention-based neural network model.
